(19) United States
(12) Patent Application Publication
(10) Pub. No.: US 2006/0242186 A1
(43) Pub. Date: Oct. 26, 2006

(54) Thermal signature intensity alarmer system and method for processing thermal signature

(76) Inventor: Thomas J. Hurley, Mount Airy, MD (US)

Correspondence Address: BARTUNEK & BHATTACHARYYA, LTD., 10420 LITTLE PATUXENT PARKWAY, SUITE 405, COLUMBIA, MD, 21044-3533, US

(21) Appl. No.: 11/114,898

(22) Filed: Apr. 26, 2005

(51) Int. Cl. G06F 7/00

(52) U.S. Cl. 707/102

(57) ABSTRACT

A system and method for processing thermal signature data is provided. The system provides a thermal signature data processor that analyzes one or more pixels to determine whether an aspect of an alarm-worthy event has occurred. In one embodiment, the system analyzes visual data with relation to the thermal signature data to determine whether an alarm-worthy event (e.g., intrusion) has occurred and subsequently generates an alarm to indicate an intrusion or alarm-worthy event.

### BACKGROUND OF THE INVENTION

Motion detection by visual processing is well known in the art. For example, U.S. Pat. No. 6,504,479 discloses various systems and methods for motion detection. Similarly, thermal imaging via infrared (IR) is well known in the art. For example, an intruder alert system that employs IR is described in U.S. Pat. No. 5,825,413. Each, however, suffers from drawbacks that produce sub-optimal motion detection and/or intruder alert systems.

Conventional systems, particularly those employed in a visually noisy environment, may generate false positives (e.g., false alarms). For example, a motion detector outside a barn door may trigger an alarm due to the activity of a raccoon, or, on a windy night, when a tarpaulin covering a nearby woodpile flaps in the wind. Similarly, a heat detector inside a warehouse may trigger an alarm due to the activity of a rat, or a motion detector may alarm when the air conditioning system engages and blows scrap paper across the detection system field of view. False alarms may also be generated due to changing light conditions that produce apparent motion and/or thermal signature changes. By way of illustration, the rising sun may generate a thermal signature change directly and/or in items reflecting the sun. Furthermore, shadows and refractions may cause thermal signature changes. The present invention overcomes the drawbacks of the prior art and is discussed hereinbelow.

Terminology

The following terms and their definitions are utilized in the present invention. These terms are not intended to be limiting, but provide clarity for the purposes of understanding the present invention.

Computer component refers to a computer-related entity, either hardware, firmware, software, a combination thereof, or software in execution. For example, a computer component can be, but is not limited to being, a process running on a processor, a processor, an object, an executable, a thread of execution, a program and a computer. By way of illustration, both an application running on a server and the server can be computer components. One or more computer components can reside within a process and/or thread of execution and a computer component can be localized on one computer and/or distributed between two or more computers.

Computer communications refers to a communication between two or more computer components and can be, for example, a network transfer, a file transfer, an applet transfer, an email, a hypertext transfer protocol (HTTP) message, a datagram, an object transfer, a binary large object (BLOB) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

Logic includes, but is not limited to hardware, firmware, software and/or combinations of each to perform a function(s) or an action(s). For example, based on a desired application or needs, logic may include a software-controlled microprocessor, discrete logic such as an application specific integrated circuit (ASIC), or other programmed logic device. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

Signal includes, but is not limited to, one or more electrical or optical signals, analog or digital, one or more computer instructions, a bit or bit stream, or the like.

Software includes, but is not limited to, one or more computer readable and/or executable instructions that cause a computer, computer component, and/or other electronic device to perform functions, actions and/or behave in a desired manner. The instructions may be embodied in various forms like routines, algorithms, modules, methods, threads, and/or programs. Software may also be implemented in a variety of executable and/or loadable forms including, but not limited to, a stand-alone program, a function call (local and/or remote), a servelet, an applet, instructions stored in a memory, part of an operating system or browser, and the like. It is to be appreciated that the computer readable and/or executable instructions can be located in one computer component and/or distributed between two or more communicating, co-operating, and/or parallel processing computer components and thus can be loaded and/or executed in serial, parallel, massively parallel and other manners. It will be appreciated by one of ordinary skill in the art that the form of software may be dependent on, for example, requirements of a desired application, the environment in which it runs, and/or the desires of a designer/programmer or the like.

An operable connection (or a connection by which entities are “operably connected”) is one in which signals, physical communication flow, and/or logical communication flow may be sent and/or received. Usually, an operable connection includes a physical interface, an electrical interface, and/or a data interface, but it is to be noted that an operable connection may consist of differing combinations of these or other types of connections sufficient to allow operable control.

Data store refers to a physical and/or logical entity that can store data. A data store may be, for example, a database, a table, a file, a list, a queue, a heap, and so on. A data store may reside in one logical and/or physical entity and/or may be distributed between two or more logical and/or physical entities.

### SUMMARY OF THE INVENTION

It is, therefore, the objective of the present invention to provide a system that operates with IR camera signals to generate thermal signature intensity alarming.

It is yet another objective of the present invention to provide a system that operates with IR camera signals to provide motion detection.

It is yet another objective, a system combines IR camera signal thermal signature intensity alarming with IR camera signal motion detection.

It is yet another objective of the present invention to provide a system and method that allows intrusion detecting systems and visual processing to be combined with thermal signal processing.

These and other objectives are realized in the present invention.

### BRIEF DESCRIPTION OF THE DRAWINGS

FIG. 1 shows a thermal signature intensity alarming system of the present invention.

FIG. 2 shows a thermal signature motion alarming system of the present invention.

FIG. 3 shows a combination thermal signature intensity and thermal signature motion alarming system of the present invention.

FIG. 4 shows a thermal signature intensity and visual image alarming system of the present invention.

FIG. 5 shows a method for thermal signature intensity alarming of the present invention.

FIG. 6 shows a method for thermal signature motion alarming of the present invention.

FIG. 7 shows a method for combined thermal signature intensity and thermal signature motion alarming of the present invention.

FIG. 8 shows a method for combined thermal signature intensity and visual image processing alarming of the present invention.

FIG. 9 shows an alarm determining subroutine of the present invention.

FIG. 10 shows a thermal signature intensity identification system of the present invention.

FIG. 11 shows a thermal signature intensity identification system with associated range finding logic of the present invention.

FIG. 12 shows a thermal signature intensity processing system with associated tracking logic of the present invention.

FIG. 13 shows a combined thermal signature intensity and visual image processing system with associated tracking logic of the present invention.

FIG. 14 shows a combined thermal signature intensity and visual image processing system with other sensors and associated tracking logic of the present invention.

FIG. 15 is a schematic block diagram of a computing environment with which the example systems and method can interact of the present invention.

FIG. 16 shows a data packet of the present invention.

FIG. 17 shows subfields in a data packet of the present invention.

FIG. 18 shows an application programming interface (API) of the present invention.

FIG. 19 shows a screen shot from a thermal signature intensity alarming system of the present invention of the present invention.

FIG. 20 shows a screen shot from a thermal signature intensity alarming system of the present invention.

FIG. 21 shows another screen shot from a thermal signature intensity alarming system of the present invention.

FIG. 22 shows yet another screen shot from a thermal signature intensity alarming system of the present invention.

### DETAILED DESCRIPTION OF THE EMBODIMENTS

The thermal imaging system and method of the present invention is discussed utilizing embodiments and illustrative examples. The present invention is not limited to these specific embodiments and examples. Rather, as understood by one of ordinary skill in the art, the present invention includes any and all variations and examples that are within the scope of the thermal imaging system and method discussed below.

Portions of the present invention are presented in algorithms and symbolic representations of operations on data bits within a computer memory. These algorithmic descriptions and representations are the means used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, it is appreciated that throughout the description, discussions utilizing terms like processing, computing, calculating, determining, displaying, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Flexible Sequences and Functionally Equivalent Circuits

It will be appreciated that some or all of the methods described herein involve electronic and/or software applications that may be dynamic and flexible processes so that they may be performed in sequences different than those described herein. It will also be appreciated by one of ordinary skill in the art that elements embodied as software may be implemented using various programming approaches such as machine language, procedural, object oriented, and/or artificial intelligence techniques.

The processing, analyses, and/or other functions described herein may also be implemented by functionally equivalent circuits such as a digital signal processor (DSP), a software controlled microprocessor, or an ASIC. Components implemented as software are not limited to any particular programming language. Rather, the description provides the information one skilled in the art may use to fabricate circuits or to generate computer software and/or computer components to perform the processing of the system. It will be appreciated that some or all of the functions and/or behaviors of the example systems and methods may be implemented as logic as defined above.

The systems and methods of the present invention are directed to processing IR signals, alone and/or in combination with other signals, including but not limited to, visual image data, pressure sensing data and sound sensing data.

In a preferred embodiment, the systems and methods of the present invention operate on an IR signal; examining the thermal signature of one or more items in a field of view, comparing them with user specifiable parameters concerning thermal signatures, and determining whether the field of view contains an item within thermal alarm limits. These user specifiable parameters include thermal intensity, pixel value and region of interest (ROI). and region of interest (ROI) Another attribute, motion is a fixed, predetermined attribute. It is also important to note that the parameters and attributes listed above are not limiting and other parameters and attributes capable of operating are also considered to be within the scope of the present invention. The thermal signature obtained in accordance with the present invention is based upon the difference of the thermal intensity of an object compared to the background thermal intensity in a field of view/ROI. Thus, by setting a threshold based on the intensity of a predetermined field of view, any thermal intensities that exceed the intensity levels set for that field will generate an alarm.

However, it is understood that the system of the present invention must also be able to account for thermal intensity masking. Thermal intensity masking are defined as situations where an alarm worthy target in motion become masked by a thermal signature of another alarm worthy target not in motion, but of equal or greater thermal intensity and equal or greater pixel value. In such cases the visual camera serves as the priority camera for motion and pixel value. Here, the priority attributes are motion and pixel value until such time when the non moving thermal pattern interference is no longer in the same field of view as the target in motion (which would be considered the priority target based on more alarm worthy attributes).

Thermal masking is one of several examples when visual imaging of the system of the present invention takes priority over IR imaging. Other known symptoms are dependent upon environmental characteristics as understood by one of ordinary skill in the art. Thus, while thermal imaging is the preferred embodiment of the present invention, visual imaging still remains a pertinent and alternative means to develop an imaging mechanism as per the present invention.

In most case, however, visual imaging camera is a redundant function of lesser attributes and serves as a validation tool to IR imaging for those redundant attributes. Alarm worthy events are far more probable in the visual spectrum because visual imaging becomes less effective at low light or night functions. It is under such conditions that thermal imaging, as per the present invention is the priority function. Alternatively, thermal imaging is also more effective when visual masking occurs. Visual masking is defined as a situation when the light value is too high for difference detection using a visual imaging system. Thus, as discussed below, the combination of both the thermal and visual imaging system is further needed to provide a full scope imaging system.

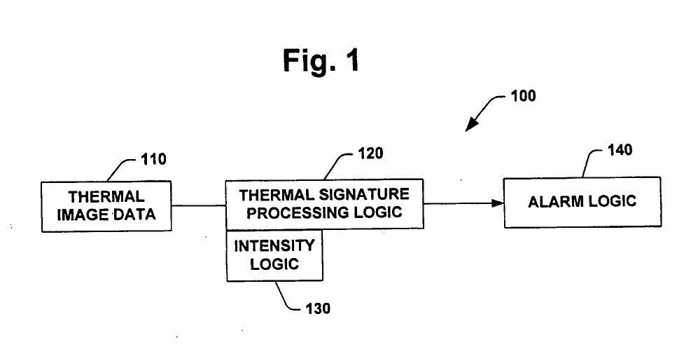

FIG. 1 of the present invention shows a thermal signature intensity alarming system 100. The alarming system 100 includes a thermal signature processing logic 120 that receives a thermal image data 110. The thermal image data 110 is obtained from an imaging camera (not shown). In a preferred embodiment the imaging camera is an infrared (IR) camera. In a preferred embodiment, infrared cameras having a standard response of 3 to 5 microns mid-band or 8-12 microns long-wave are desired. In another preferred embodiment, it is important to note that camera limitations must be accounted for. By current industry standards, the systems of the present invention must meet or exceed 160×120, 320×240 and 640×480 lines of resolution. In yet another preferred embodiment, IR cameras having a thermal resolution of equal or greater than a Noise Equivalent Temperature Difference (NETD) of 0.10° C.

The thermal signature processing logic 120 processes the thermal image data 110 to identify an object of interest via its thermal signature, as discussed above. The system 100 also includes an intensity logic 130 that determines the relative intensity of the object of interest based upon a difference between the thermal intensity background of the field and the thermal intensity of the objects in the field of view.

In a preferred method utilizing system 100 as shown in FIG. 1, the background of a field of view generates a first thermal intensity. If one or more objects in the field of view generate thermal signature intensities different from the first thermal intensity; and if the object generated thermal signature intensity differs from the background intensity and falls within a pre-determined, configurable range of intensities, then the system 100 identifies the object as being an object of interest. Then, alarm logic 140 examines potential objects of interest and subjects them to comparisons with various other pre-determined, configurable attributes, such as but not limited to ROI or the pixel value, to determine whether an alarm signal should be generated. Thus, the system 100 includes an alarm logic 140 that determines whether an alarm-worthy event has occurred based on the thermal signature processing logic 120 analysis of the thermal image data 110 and/or the intensity logic 130 analysis of the relative thermal intensity of the object of interest.

In an embodiment of the present invention, one output from the thermal signature target recognition system 100 is an alarm. The alarm is based on a probability function for identifying a given target. For example, the system may produce a determination that there is an x % likelihood that the target is one for which an alarm should be generated. By way of illustration, the system may generate an output that it is 75% likelihood that the item for which a thermal signature was detected is a human and a 10% likelihood that the item is a small animal.

In a preferred embodiment, the alarm logic 140 determines whether an alarm-worthy event has occurred based on threshold values produced by the thermal signature processing logic 120 and/or the intensity logic 130 where the values are produced by processing the value of an individual pixel or a set of pixels. It is important to note that threshold values are actually threshold vales of acceptance based upon thermal images having a set value of grey tones (e.g. 256 levels of grey), thereafter defining a threshold region ranging from a coldest region of grey to a hottest region of grey.

The following examples illustrate single pixel processing as compared to average effect processing. A region thermal threshold is examined to determine whether an object changed the average thermal signature in the image enough to raise an alarm.

### EXAMPLE 1

A human who is a mile from a system, as per in the present invention, registers as a single pixel in an image. Although the single pixel is within the object thermal threshold (e.g., z % thermal intensity difference), the overall effect on the average thermal signature of the image is too small to warrant an alarm.

In this way, large warm objects that are beyond a desired range of interest (e.g., not within 50 yards of the sensor) can be ignored and not produce false alarms.

### EXAMPLE 2

A small rodent (e.g., rat) inside the range of interest is detected. Its thermal image is placed within the object thermal threshold (e.g., z % thermal intensity difference). Although more than one pixel may be affected, its overall effect on the average thermal signature of the image would be too small to warrant an alarm.

In this way, small warm objects that are within the desired range of interest can also be ignored and not produce false alarms.

Thus, the alarm logic 140 can determine whether an alarm-worthy event has occurred based on threshold values produced by the thermal signature processing logic 120. Alternatively, the alarm logic 140 can also determine whether an alarm-worthy event has occurred based on the values that are produced by processing the effect an individual pixel or set of pixels has on an average value for a region of interest utilizing the intensity logic 130. In a preferred embodiment, alarm logic 140 can utilize both the signature processing logic 120 and the intensity logic 130 to produce a unique alarm-worthy event.

The system 100 may be implemented, in some examples, in computer components. Thus, in a preferred embodiment, portions of the system 100 are distributed on a computer readable medium storing computer executable components of the system 100.

In addition, it is also within the scope of the present invention, that the imaging method of system 100 as shown in FIG. 1 and discussed above, can be accomplished by implementing a greater and/or lesser number of logics, and/or in a greater and/or lesser number of computer components.

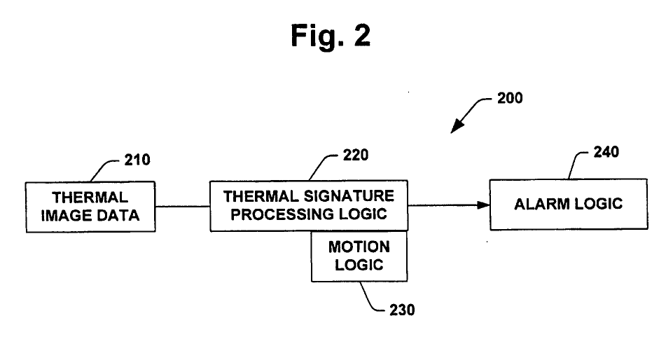

A thermal signature motion alarming system 200 of the present invention is shown in FIG. 2. The system 200 includes a thermal signature processing logic 220 that receives a thermal image data 210. The thermal image data 210 is obtained from an imaging camera (not shown). In a preferred embodiment the imaging camera is an infrared (IR) camera having the characteristics discussed above. The thermal signature processing logic 220 processes the thermal image data 210 to identify an object of interest via its thermal signature. The system 200 also includes a motion logic 230 that determines whether the object of interest has moved.

In a preferred method utilizing system 200, as shown in FIG. 2, the object of interest appears in a first image at a first location. The object of interest may then appear in a second image at a second location. If the locations differ to within a pre-determined, configurable range of values, then the system 200 identifies the object as being an object of interest that has moved. The alarm logic 240 examines these potential objects of interest and subjects them to comparisons with various other pre-determined, configurable attributes to determine whether an alarm signal should be generated. These pre-determined, configurable attributes include, but are not limited to, thermal intensity, pixel value, motion and region of interest (ROI). Thermal intensity, pixel value and region of interest are user selectable whereas motion is a fixed predetermined attribute.

Thus, the alarm logic 240 determines whether an alarm-worthy event has occurred based on the thermal signature processing logic 220 analysis of the thermal image data 210. Alternatively, the alarm logic 240 determines an alarm-worthy event based on an analysis of the motion of the object of interest utilizing the thermal image data 230. In a preferred embodiment, alarm logic 240 utilizes both the thermal signature processing logic 220 and the motion logic 230 to produce a unique alarm worthy event.

The system 200 may be implemented, in some examples, in computer components. Thus, in a preferred embodiment, portions of the system 200 are distributed on a computer readable medium storing computer executable components of the system 200.

In addition, it is also within the scope of the present invention, that the imaging method of system 200 as shown in FIG. 2 and discussed above, can be accomplished by implementing a greater and/or lesser number of logics, and/or in a greater and/or lesser number of computer components.

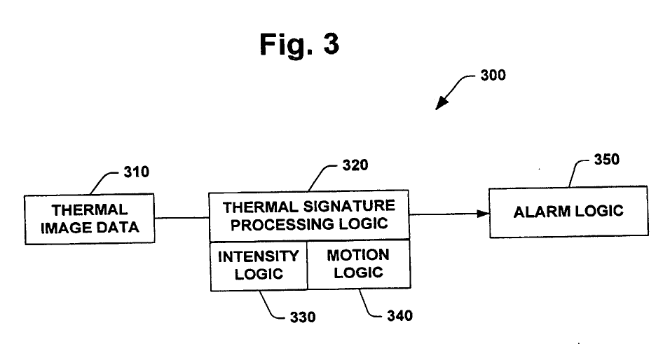

FIG. 3 of the present invention shows a combination thermal signature intensity and thermal signature motion alarming system 300. The system 300 includes a thermal signature processing logic 320 that analyzes a thermal image data 310 to facilitate identifying an object of interest in a region of interest via its thermal signature. The system 300 also includes a motion logic 340 that facilitates determining the motion of the object of interest (e.g., whether it has moved). This determination can be made in a manner similar to that described above in conjunction with FIG. 2 via frame deltas (the difference between frames).

The system 300 as shown in FIG. 3 includes an intensity logic 330 that facilitates determining the relative thermal signature intensity of the object of interest and an alarm logic 350. This determination is made in a manner similar to that described above with respect to FIG. 1. The alarm logic 350 determines whether an alarm-worthy event has occurred based on the thermal signature processing logic 320 analysis of the thermal image data 310, the motion logic 340 analysis of the motion of the object of interest, and/or the intensity logic 330 analysis of the relative thermal intensity of the object of interest.

In an embodiment of the present invention, the alarm logic 350 determines whether an alarm-worthy event has occurred based on threshold values produced by the thermal signature processing logic 320, the motion logic 340, and/or the intensity logic 330 where the values are produced by processing the value of an individual pixel or a set of pixels. It is important to note that threshold values are actually threshold vales of acceptance based upon thermal images having a set value of grey tones (eg. 256 levels of grey), thereafter defining a threshold region ranging from a coldest region of grey to a hottest region of grey.

In another embodiment of the present invention, the alarm logic 350 determines whether an alarm-worthy event has occurred based on values produced by the thermal signature processing logic 320, the motion logic 340, and/or the intensity logic 330, where the values are produced by processing the effect an individual pixel or set of pixels has on an average value for a region of interest.

The system 300 may be implemented, in some examples, in computer components. Thus, in a preferred embodiment, portions of the system 300 are distributed on a computer readable medium storing computer executable components of the system 300. In addition, it is also within the scope of the present invention, that the imaging method of system 300 as shown in FIG. 3 and discussed above, can be accomplished by implementing a greater and/or lesser number of logics, and/or in a greater and/or lesser number of computer components.

Systems 100 as shown in FIG. 1, system 200 as shown in FIG. 2 and system 300, as shown in FIG. 3 are also configured to utilize and process a combination visual and IR camera signals. Utilizing visual and IR camera signals allows for the formation of a composite image where items with an interesting thermal signature, and/or items with an interesting thermal signature that moved, can be identified and presented to a user while visual imaging continues. The ability to combine visual and IR camera signal enhances both day and night surveillance in a field of view. The visual image data acquired by an optical camera can be combined through a mathematical function with thermal image data acquired by a thermal camera to produce a motsig data. The motsig data thus captures elements of both the visual image and the thermal image. By creating a composite visual and IR image, the visual daytime capability of a visual camera is enhanced. The composite visual and IR image can be created by overlaying relevant IR data over visual data. Relevant IR data can be data that is, for example, acquired from an object within user specifiable intensity thresholds.

The following example illustrate the method of utilizing the combination of visual and IR data.

### EXAMPLE 3

A warm object (e.g., small rodent) moves across a region of interest in a field of view. Thermal signature processing identifies that an object within specified thermal intensity parameters is in the field of view. For example, an object's thermal threshold may be examined to determine whether the object is warm enough to be of interest without being too warm (e.g., x % warmer than the background in the field of view without being y % warmer). Then, visual frame difference analysis determines that the item with the interesting thermal signature has moved by identifying such movement as the object's path, its location and other such parameters. By utilizing the thermal intensity parameters and the visual frame analysis, the systems of the present invention can determine whether an alarm-generating event has occurred. Thus, combination processing can determine whether the occurrence is an alarm-worthy event.

The systems of the present invention can also determine, via visual processing, whether an object of interest has moved in a region of interest in the field of view. Rather than immediately generating an alarm signal condition and/or taking some other action (e.g., turning on a security light), the systems of the present invention can engage in additional thermal signature processing to determine not only that an object has moved, but also the heat signature of what moved and whether it is of interest to the systems.

It is also within the scope of the present invention that the additional thermal signature processing can be performed in serial and/or substantially in parallel with the visual processing. Additionally, and/or alternatively, the systems of the present invention can determine, via thermal signature processing, that an object of potential interest is in a region of interest in the field of view. Then, additional visual processing can be employed to determine whether the object is actually of interest. Thus, the outline of the object with the interesting thermal signature can be acquired using image processing and target tracking can be applied to the detected and outlined object.

The process of combining visual image data and IR data also produces a true positive (e.g., real alarm). Unlike conventional alarms that may not detect a slow-moving, large warm objects, a combination of visual and IR signal processing can detect a stealthy intruder based upon the change in the overall thermal signature in the region of interest in the field of view, and generate a real-time alarm.

It is, therefore, within the scope of the present invention, that the thermal signature processing and the visual processing can occur individually, substantially in parallel, and/or serially, with either the thermal or visual processing going first and selectively triggering complimentary combination processing.

It is also within the scope of the present invention to adjust processing parameters, such as operator settings and/or detected environmental factors. Thus, the systems of the present invention can be fine-tuned to weigh the relative advantages of visual analysis and thermal signature analysis based upon these parameters and generate an alarm, if necessary.

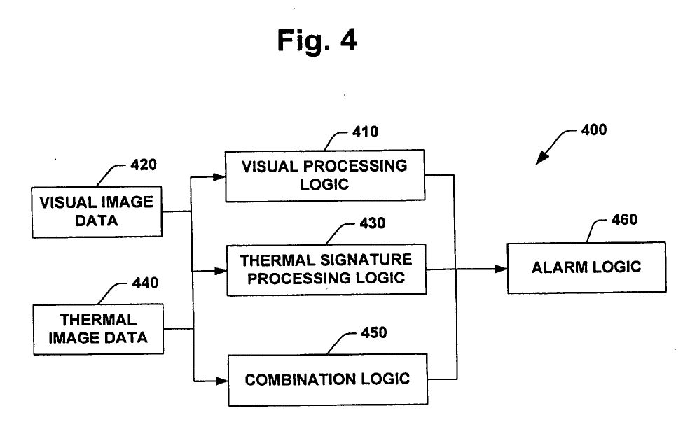

In addition to the combination of visual image analysis and thermal image analysis discussed above, thermal signature intensity and visual image alarming system 400 is shown in FIG. 4 of the present invention. The system 400 includes a visual processing logic 410 that analyzes a visual image data 420.

The system 400, as shown in FIG. 4, is configured to process for edge detection, shape detection and other image generating parameters. The system 400 includes a thermal signature processing logic 430 that analyzes thermal image data 440 similar to that discussed in FIGS. 1, 2 and 3, above. The system 400 also includes a combination logic 450 that analyzes a combination of the visual image data 420 and the thermal image data 440. The combination logic 450 determines one or more relationships between one or more objects in the visual image data 420 and the thermal image data 440. The system 400 also includes an alarm logic 460 that determines whether an alarm-worthy event has occurred, based on one or more of the visual processing logic 410 analysis of the visual image data 420, the thermal signature processing logic 430 analysis of the thermal image data 440 and the combination logic 450 analysis of the combination of the visual image data 420 and the thermal image data 440 or relationships between objects in them. The visual processing logic 410 is operably connected to a frame capturer that captures between 10 and 60 frames per second. The frame capturer may be, for example, a PCI frame grabber. While a PCI frame grabber is described, it is to be appreciated that other types of frame grabbers (e.g., USB) can be employed. Similarly, while 10 to 60 frames per second are described, it is to be appreciated that other rangers can be employed. The visual image data 420 can be acquired from a single frame and/or from two or more frames. The PCI frame grabber may sample data at a resolution of between 128.times.128 pixels and 1024.times.1024 pixels with a color depth of between 4 and 16 bits per pixel. While 128.times.128 to 1024.times.1024 pixels are described, it is to be appreciated that other ranges can be employed. The visual processing logic 410 includes a visual image data transforming logic. The visual image transforming logic may perform actions including, but not limited to, blurring, sharpening, and filtering the visual image data 420. The alarm logic 460 determines whether an alarm-worthy event has occurred by evaluating the value of one or more pixels in the visual image data 420 or the thermal image data 440 on an individual basis. Additionally and/or alternatively, the alarm logic 460 can determine whether an alarm-worthy event has occurred by evaluating values of a set of pixels in the visual image data 420 or the thermal image data 440 on an averaged basis. The alarm logic 460 determines whether an alarm-worthy event has occurred by comparing a motsig data to a pre-determined, configurable range for the motsig data. The system 400 can be implemented, in some examples, in computer components. Thus, portions of the system 400 are distributed on a computer readable medium storing computer executable components of the system 400. In addition, the imaging method of system 400 as shown in FIG. 4 and discussed above, can be accomplished by implementing a greater and/or lesser number of logics, and/or in a greater and/or lesser number of computer components.

The system 400 can be employed to implement an intrusion detector. In one embodiment, an infrared and visual intrusion detector includes an intruder infrared (IIR) module and a computer component on which associated application software will run. The infrared and visual intrusion detector can then be operably connected to other components including, but not limited to, a pan and tilt system that facilitates acquiring image and/or thermal data from a desired region of interest and a display system that facilitates displaying acquired and/or transformed image and/or thermal data.

Similarly, an IIR module and computer components for running associated application software can cooperate to produce a display. The display can be presented on a computer monitor, a television or other display means. Thus, the IIR module and computer components for running associated application software may be operably connected by a National Television System Committee (NTSC) connection to a television. Similarly, the IIR module and computer components for running associated software can be connected to a computer monitor or the like. The computer monitor and the television can display substantially similar images at substantially the same time but with different resolutions and image size.

An IIR module has two logical processes. One process manages matters including, but not limited to, image acquisition, processing, and distribution while a second process facilitates actions including, but not limited to, commanding and controlling the IIR module and interfacing with a pan and tilt unit that houses an optical and/or thermal (e.g., IR) camera from which the images are acquired. While an infrared image acquisition is described, it is to be appreciated that other forms of thermal imagery can be employed.

In another embodiment of the present invention, image processing can include various logical activities. Although four activities are described, it is to be appreciated that a greater and/or lesser number of activities can be employed. Furthermore, while the activities are described sequentially, it is to be appreciated that the activities can be performed substantially in parallel.

One activity concerns frame capturing. In another embodiment, image data can be acquired at approximately 30 frames per second (FPS) using a PCI frame grabber. Data may be sampled at a resolution of 320.times.240 pixels with a color depth of 8 bits per pixel (BPP). While approximately 30 FPS are described, it is to be appreciated that a greater and/or lesser number of FPS can be employed. Similarly, while a resolution of 320.times.240 is described, varying resolutions (e.g.,

1024.times.1024) can be employed. Furthermore, while a color depth of 8 BPP is described, it is to be appreciated that different color depths can be used. Further still, while a PCI frame grabber is described, other frame grabbers (e.g., USB) can be employed.

Another activity concerns image transformation. Image transformation can include, but is not limited to, blurring image data, sharpening image data, and filtering image data through, for example, low pass, high pass, and/or bandpass filters. Image transformation can also include performing edge detection operations. In one example, for efficiency, transformations are processed in a spatial domain using 3.times.3 kernels, although other kernel sizes may be employed.

Another activity concerns alarm testing. Alarm testing can concern a combination of three parameters. One parameter, the mode parameter determines whether data to be evaluated is taken from a single frame, distinct frames, and/or differences between frames (frame deltas). Another parameter, the evaluation mechanism parameter determines whether an alarm will be triggered based on pixel data from an individual pixel, a set of pixels, and/or an average pixel value from a region of interest. Another parameter, value range, establishes and/or maintains boundaries for an alarm range.

### EXAMPLE 4

In a mammal intrusion system, a temperature value range can be established to facilitate generating alarms only for items with a thermal intensity greater than a lower threshold and/or less than an upper threshold.

### EXAMPLE 5

In an industrial pollutant intrusion system where certain toxic chemical byproducts may be produced, a thermal intensity range can be established that corresponds to a relative difference of approximately 100 degrees Celsius.

### EXAMPLE 6

In a missile intrusion system programmed to detect re-entering ballistic missiles, the thermal intensity range can be established to correspond to a relative difference of approximately 1,000 degrees Celsius.

In combination systems, an associated tracking velocity and/or motion displacement can also be established. That is, parameters can be established and/or manipulated to account for such scenarios as a branch gently swaying back and forth in a breeze with a warm bird perched on the branch. Though there is motion, and a thermal signature, this is not the type of event for which an alarm signal is desired. Thus, so long as the velocity of the warm object remains within a certain range, determined by the pre-established thermal threshold and so long as the distance moved by the object remains below a certain threshold by setting up a motion parameter within the ROI), no alarm signal will be generated. The alarm testing may be applied to one or more arbitrary regions of interest (ROI). An ROI may have its own alarm parameters.

Another activity concerns image distribution. Image data can be colorized according to a pre-determined, configurable palette and distributed to display components like a computer monitor and/or television. Upon the occurrence of actions including, but not limited to, an alarm and a request from an associated application, image data can be stored in a data store and/or on a recordable medium. Thus, an image can be sent to disk, videotape or other such recordable means. Since the image data may traverse a computer network in a computer communication, the image data can be compressed using a Coarse Sampling and Quantization (CSQ) method, or the like.

Various application software can be associated with the systems and methods described herein. For example, application software including, but not limited to, software that facilitates controlling visual and/or thermal imagers, controlling a pan/tilt unit, controlling imaging, and controlling alarming can be associated with the example systems and methods.

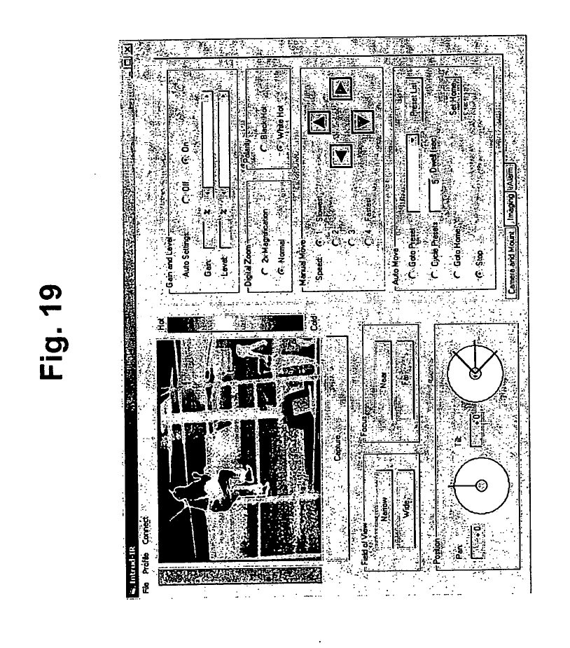

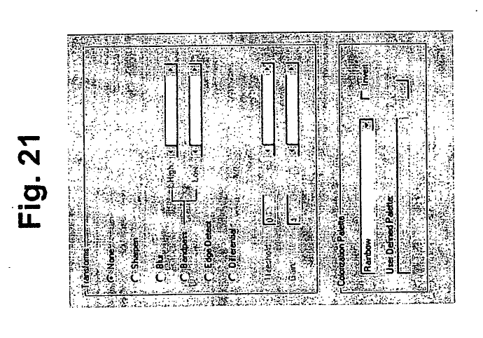

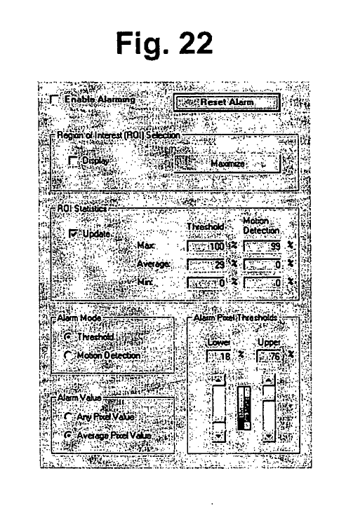

An image controller software can be used to adjust imager focus and imager field of view; establish and/or adjust automatic settings and/or manual settings; adjust gain, filter levels, polarity, zoom, and the like. Information associated with image controlling can be presented via a graphical user interface using a variety of graphical user interface (GUI) elements (e.g., graphs, dials, gauges, sliders, buttons) in a variety of formats (e.g., digital, analog). Some example GUI elements are illustrated in FIG. 19 through FIG. 22. The images shown in FIG. 19 through FIG. 22 are copyrighted images owned by Raytheon Company, used with permission by the present inventor, for the purposes of explaining the method and system of the present invention.

An example pan/tilt controller application facilitates manually and/or automatically panning and/or tilting a unit on which an optical camera and/or a thermal camera are mounted. A pan/tilt controller may facilitate establishing parameters including, but not limited to, panning and/or tilting speeds, cycle rates, panning and/or tilting patterns, and so on. Information associated with pan/tilt control may be presented, for example, via a graphical user interface using a variety of graphical user interface elements in a variety of formats.

In a preferred embodiment, imaging control application facilitates establishing and/or maintaining parameters associated with transforming acquired data. For example, color palettes may be established and/or maintained to facilitate colorizing data. Again, information associated with imaging control applications can be presented through a GUI.

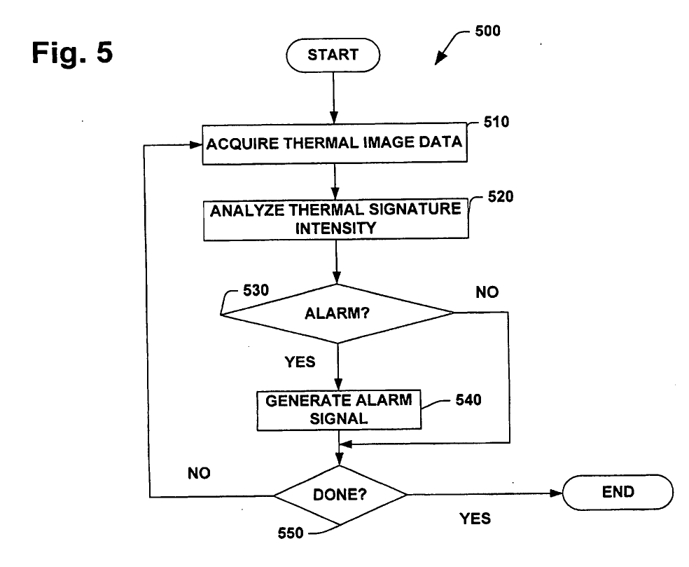

In view of the systems shown and described hereinabove, methodologies of the present invention that are utilized with respect to the disclosed systems are discussed with reference to the flow diagrams of FIG. 5 through FIG. 9.

A flow diagram format has been utilized to discuss the methodologies of the present invention. The formats shown in FIG. 5 through FIG. 9 are for the purposes of explanation, and is not intended to limit the sequential order or be limiting to the specific steps involved in how the systems of the present invention operate. Thus methodologies involving lesser or greater steps than those outlined in FIG. 5 through FIG. 9 are also within the scope of this invention. It is also understood to one of ordinary skill that the methodologies of the present invention can be formatted to include computer executable instructions and/or operations; and stored on computer readable media including, but not limited to an application specific integrated circuit (ASIC), a compact disc (CD), a digital versatile disk (DVD), a random access memory (RAM), a read only memory (ROM), a programmable read only memory (PROM), an electronically erasable programmable read only memory (EEPROM), a disk, a carrier wave, and a memory stick.

In the flow diagrams of the present invention, rectangular blocks denote “processing blocks” that may be implemented, for example, in software. Similarly, the diamond shaped blocks denote “decision blocks” or “flow control blocks” that may also be implemented, for example, in software. Alternatively, and/or additionally, the processing and decision blocks can be implemented in functionally equivalent circuits like a digital signal processor (DSP), an ASIC, and the like.

The flow diagrams of the present invention do not depict syntax for any particular programming language, methodology, or style (e.g., procedural, object-oriented). Rather, each of the flow diagrams of the present invention illustrate functional information one skilled in the art may employ to program software, design circuits, and so on. It is to be appreciated that in some embodiments, program elements like temporary variables, initialization of loops and variables, routine loops, and so on are not shown. Furthermore, while some steps are shown occurring serially, it is to be appreciated that some illustrated steps may occur substantially in parallel.

FIG. 5 of the present invention shows a method 500 for thermal signature intensity alarming. The method 500 includes, a step of acquiring a thermal image data 510. The thermal image data may be acquired from a thermal imaging camera. In a preferred embodiment the thermal imaging camera is an IR camera. The method 500 also includes a step of analyzing the thermal image data to identify a thermal signature intensity for an object of interest in a region of interest, 520. The analysis 520 can include the step of identifying regions where thermal intensity values change, i.e. gradients (not shown). Identifying locations where changes occur can assist in determining the size, shape, location, and so on of an object. Subsequent to the data acquisition step 510 and the data analysis step 520, method 500 includes the step 530, of determining whether an alarm signal should be generated based on the thermal signature intensity of the object of interest. If the determination at 530 is YES, then at 540 an alarm is selectively generated. Otherwise, processing proceeds to 550. At 550, a determination is made concerning whether to continue the method 500 or to exit. The method 500 can be implemented as a computer program and thus may be distributed on a computer readable medium holding computer executable instructions.

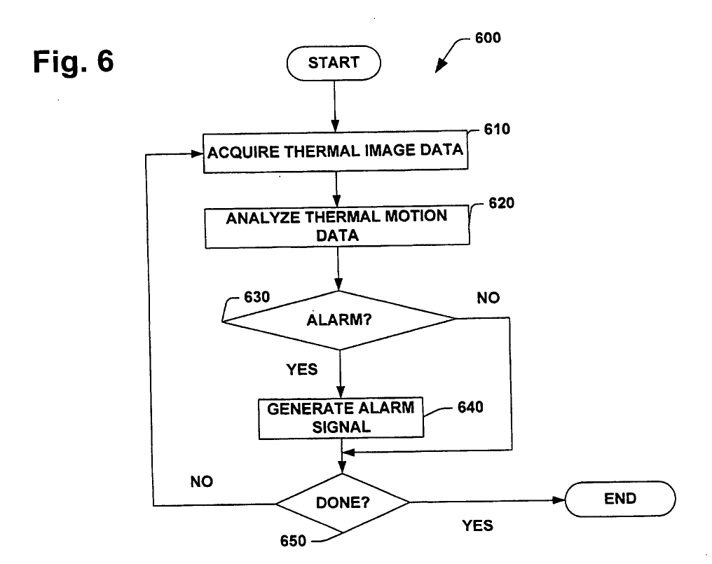

FIG. 6 of the present invention shows a method 600 for thermal signature motion alarming. The method 600 includes a step of acquiring a thermal image data, at 610. The thermal image data can be acquired using a thermal camera. In a preferred embodiment, the thermal camera is an IR camera. The method 600 includes the step of analyzing the thermal image data to identify a motion for an object of interest in a region of interest, at 620. The analysis can be performed by frame deltas (comparing a first frame with a second frame and identifying differences). The method 600 also includes the step of determining whether an alarm signal should be generated based on the motion of the object of interest, at 630. If the determination at 630 is yes, then an alarm signal is selectively generated, at 640. For example, a data packet may be generated and/or transmitted, an interrupt line may be manipulated, a data line may be manipulated, a sound may be generated, a visual indicator may be generated, and so on, at 650. Subsequent to the determination step 630 and/or the alarm generation step 640, method 600 includes a determination concerning whether to continue processing. The method 600 may be implemented as a computer program and thus may be distributed on a computer readable medium holding computer executable instructions.

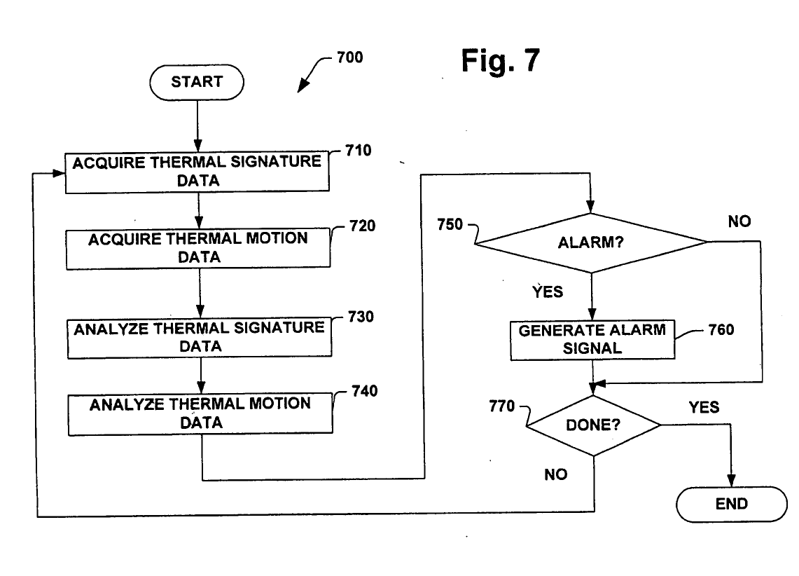

FIG. 7 of the present invention shows a method 700 for combined thermal signature intensity and thermal signature motion alarming. The method 700 includes a step of acquiring thermal signature data, at 710. The data can be acquired using a thermal camera. In a preferred embodiment, the thermal camera is an IR camera. The method 700 also includes the step of acquiring a thermal motion data, at 720. While two actions, acquiring thermal signature data and acquiring thermal motion data, are illustrated, it is to be appreciated that the thermal signature data and the thermal motion data may both reside in a thermal image data. Subsequent to obtaining the thermal signature data at 710, the thermal data is analyzed at 730 to identify a thermal signature intensity for an object of interest in a region of interest. Analysis of thermal data includes but is not limited to an analysis of thermal signature, motion and image, analyzing the thermal data (e.g., signature, motion, image). The thermal signature intensity can be determined by identifying and relatively quantifying temperature differentials. The method 700 also includes the step of analyzing the thermal data to identify a motion for the object of interest in a region of interest, at 740. For example, frame deltas can be examined where the center of mass of the thermal signature of an object is examined. Based upon the motion of the object of interest and/or the thermal signature intensity of the object of interest, a determination is made concerning whether an alarm signal should be generated, at 750. If the determination at 750 is YES, then an alarm is selectively generated, at 760. Subsequent to steps 730, 740 and 750, a determination is made concerning whether to continue processing, at 770. If so, processing returns to 710, otherwise processing can conclude. The method 700 can be implemented as a computer program and thus may be distributed on a computer readable medium holding computer executable functions.

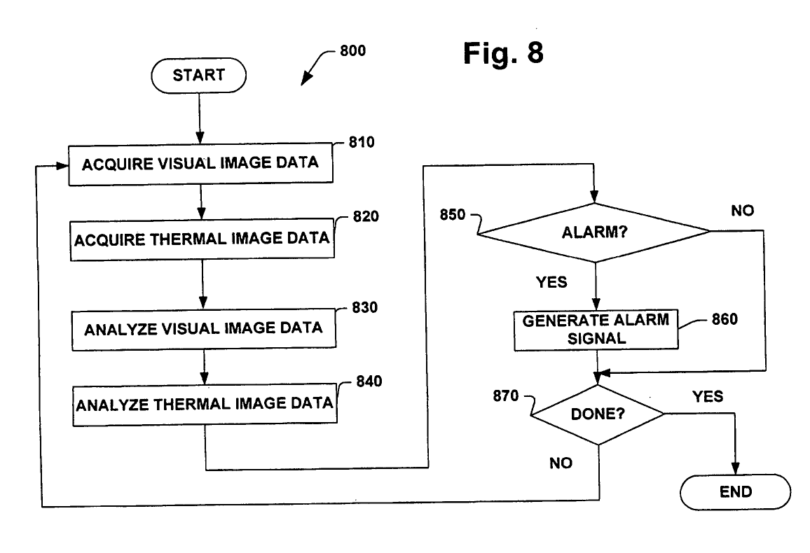

FIG. 8 of the present invention shows a method 800 for combined thermal signature intensity and visual image processing alarming. Intrusion detecting systems and methods described herein can combine visual processing (e.g., frame analysis) with thermal signature processing (e.g., IR analysis). Through visual processing of method 800, a determination can be made as to whether something has moved in a region of interest in a field of view. However, rather than immediately generating an alarm signal and/or taking some other action (e.g., turning on a security light), method 800 engages in additional thermal signature processing to determine not only that something moved, but what moved and whether it is of interest. The visual processing can be performed before the thermal signature processing, after the thermal signature processing and/or substantially in parallel with the thermal signature processing. Furthermore, it is also within the scope of the present invention to analyze visual data in relation to corresponding thermal data in circumstances warranting such analysis including but not limited to thermal masking, discussed above.

### EXAMPLE 7

To illustrate the method 800, a candy bar wrapper blows across a region of interest in a field of view in a motion detection system. A frame difference processor can determine that motion occurred. A thermal signature processor can determine that the object was cold, and thus should be ignored. Thus, the visual data (e.g., frame deltas) is analyzed in relation to the thermal image data (e.g., heat signature acquired via IR) to determine that although motion occurred in a region of interest to the system, the motion was not an intrusion by an object of interest and thus no alarm signal should be generated.

Thus, the method 800 as shown in FIG. 8 of the present invention, includes the step of acquiring a visual image data, at 810. In an embodiment of the present invention, the visual image data 810 is acquired from a frame grabber (not shown). The method 800 also includes the step of acquiring a thermal image data, at 820. In an embodiment of the present invention, the thermal image data is acquired from an infrared apparatus. The method 800 includes the step 830 where the visual image data obtained from 810 is analyzed. The method 800 also includes the step 840 where the thermal image data obtained from 820 is analyzed. The analysis at 830 and 840 is used to determine whether an alarm-worthy event has occurred. The analysis at 830 and 840 can determine whether an object with a thermal intensity signal that falls within a pre-determined configurable range has been detected, and if so, whether one or more visual attributes identify the object as being an object of interest. Thus, the method 800 includes the step of determining whether to generate an alarm signal, at 850 (e.g., toggle an electrical line, generate a data packet, generate an interrupt, send an email, generate a sound, turn on a floodlight). If the determination at 850 is YES, then an alarm signal is selectively generated based on the analyzing of the visual image data and the thermal image data, as designated as 860.

The visual image data acquired at 810 can be processed and displayed on a display (e.g., computer monitor, television screen). Various image improvement techniques can be applied to the data. Thus, the method 800 can also include transforming the visual image data by one or more of blurring, sharpening, and filtering.

As discussed in FIG. 1 through FIG. 7, above, the method 800 determines whether an alarm-worthy event has occurred based on the value of a single pixel and/or on the average value of a set of two or more pixels. Similarly, the method 800 can also determine that an alarm-worthy event has occurred based on data from a single frame and/or on data from a set of two or more frames. The method 800 can be implemented as a computer program and thus be distributed on a computer readable medium holding computer executable instructions.

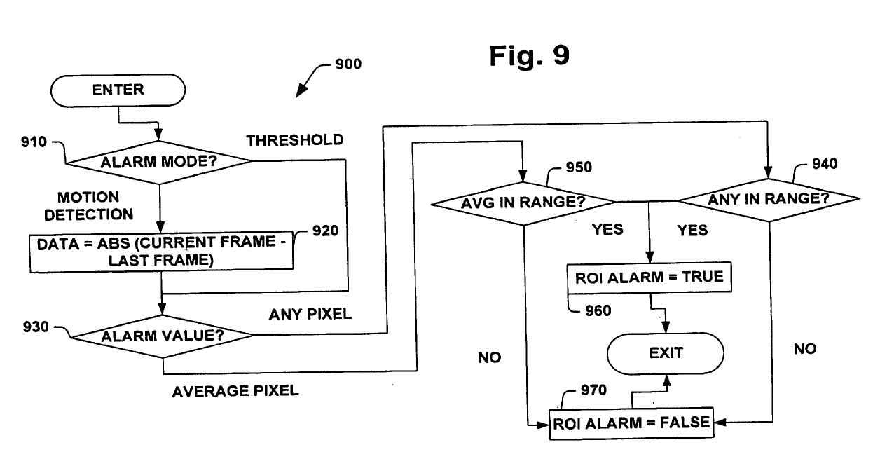

FIG. 9 of the present invention shows an alarm determining subroutine 900 for determining whether an alarm-worth event has occurred. A determination is made concerning what type of alarm mode is to be processed, at step 910. If the determination at 910 is motion detection alarming, then a frame delta data is generated by comparing a current frame with a previous frame, at step 920. This generated frame delta data determines whether an object with a thermal signature intensity that falls within a predetermined, configurable range has moved. If the determination at 910 is thermal signal intensity thresholding, then processing continues at step 930, where a determination is made concerning what type of alarm value processing is to occur. Alarm value processing types can include, but are not limited to, alarming based on the value of a single pixel, alarming based on the value of a set of pixels, alarming based on the effect of a heat signature on the overall average for a region of interest, and so on. Thus, if the determination at 930 is that alarming is based on any pixel processing, then processing continues on to step 940. If the determination at 930 is that alarming is based on average pixel values, then processing continues on to step 950. At 940, a determination is made concerning whether any pixel in the region of interest has a thermal intensity signature within a predetermined, configurable range; a pixel may have a thermal intensity signature greater than the background signature, but may not be sufficiently different to rise to the level of an item of interest. Similarly, at 950, a determination is made concerning whether the effect on the average value of pixels is within a pre-determined, configurable range. If either 940 or 950 evaluates to YES, then an alarm variable can be set to true, at step 960. Conversely, if neither 940 nor 950 evaluates to YES, then the alarm variable can be set to false, at 970.

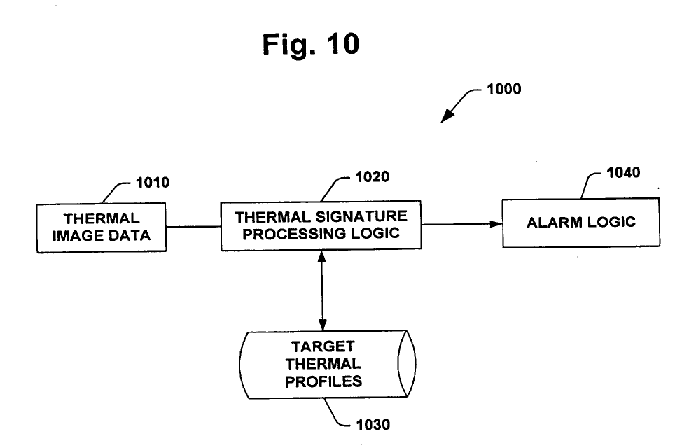

FIG. 10 of the present invention shows a thermal signature intensity identification system 1000. The system includes a thermal signature processing logic 1020 that receives and analyzes a thermal image data 1010. The thermal signature processing logic 1020 has access to a data store 1030 of target thermal profiles and is operably connected to an alarm logic 1040 that can generate an alarm signal. The thermal signature processing logic 1020 acquires the thermal image data 1010, and analyzes the thermal image data 1010 to identify a thermal signature intensity for an object of interest in a region of interest. The thermal signature processing logic 1020 also accesses a data store 1030 of thermal signatures and generates a target identification based on comparing the thermal signature identified by the thermal signature processing logic 1020 to one or more of the thermal signatures in the data store 1030.

The thermal image data 1010 can hold data that is resolved into two thermal intensity signatures by the logic 1020. A first signature can match a signature in the data store 1030, and that signature may be of an irrelevant item (e.g., rat). A second signature may match a signature in the data store 1030, and that signature may be of a relevant item (e.g., tank). Thus, the logic 1020 and the alarm logic 1040 determine whether to raise an alarm based on the matching of the signatures. In some cases, the thermal intensity signature may not match any signature in the data store 1030. In this situation the logic 1020 can take actions like, ignoring the signature, storing the signature for more refined processing, bringing the signature to the attention of an operator, adding the signature to the data store 1030 and classifying it as “recognized, not identified”, and so on.

In a preferred embodiment, the systems and methods of the present invention facilitate thermal signature based target recognition. IR signals received from a field of view are analyzed to determine whether a particular thermal signature has been detected. This is based upon an important feature of the present invention, i.e, that objects with similar visual signatures can register significantly different thermal signatures.

### EXAMPLE 8

Consider situations where a remote system is monitoring a bridge crossing. While visual processing facilitates distinguishing cars from tanks during acceptable lighting conditions (e.g., day, not a snowstorm), IR processing facilitates distinguishing tanks from cars in unacceptable lighting conditions (e.g., night, fog). When a thermal signature is detected, it can be compared to a set of stored thermal signatures to determine whether an alarm worthy item has been detected. The set of stored thermal signatures can be static and/or dynamic (e.g., trainable by programmed addition, trained by supervised learning).

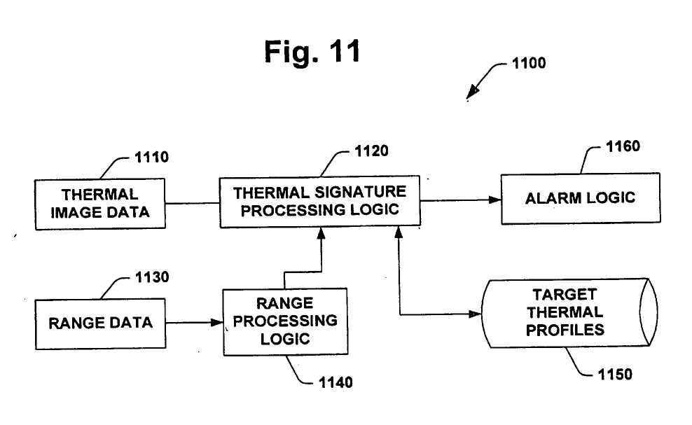

FIG. 11 of the present invention shows a thermal signature intensity identification system 1100 with associated range processing logic 1140. The system 1100 includes a thermal signature processing logic 1120 that receives and analyzes a thermal image data 1110. The system 1100 also includes alarm logic 1160 that generates an alarm signal based on the thermal signature processing and/or data generated by the range processing logic 1140. The range processing logic 1140 receives a range data 1130 from an optical source, such as a laser range finder mounted coaxially with the IR camera from which the thermal image data 1110 is gathered. The range data 1130 and the range processing logic 1140 work in conjunction with the thermal signature processing logic 1120 to determine whether thermal signatures match those stored in a data store 1150 of target thermal profiles. It is important to note that thermal signature processing of the present invention utilizes the concept that an object having a first thermal signature at a first position/distance may have a second thermal signature at a second position/distance. Thus, the range processing logic 1140 is used to decide which thermal signatures in the data store 1150 to compare to a signature produced by the logic 1120. In a preferred embodiment, the range processing logic 1140 is employed to assist automatically focusing a thermal image data device and/or a visual camera.

The systems and methods of the present invention described herein also facilitate automatically focusing a camera while tracking an object. For long range detection, lenses with long focal lengths are employed. However, lenses with long focal lengths may have a relatively small depth of field. Thus, lenses with long focal lengths may require frequent focusing to facilitate providing a viewer with an in-focus image during target tracking. Conventionally, focusing have been based on laser range finding and other similar techniques. In a preferred embodiment of the systems and methods of the present invention described herein, focusing is based on determinations made from examining the thermal gradient between a tracked target and the background. In another preferred embodiment, the focus is adjusted to maximize this gradient.

Thus, a target recognition system can be enhanced with range to target information, which may alter the probability determinations produced by the logics 1120 and/or 1160. Range to target information can be gathered, for example, from a laser range finder mounted co-axially with the thermal imager. While a laser range finder mounted co-axially is described, it is to be appreciated that range to target information may be gathered from other sources including, but not limited to, triangulation equipment, force plates, sound based systems, overhead satellite imagery systems or the like.

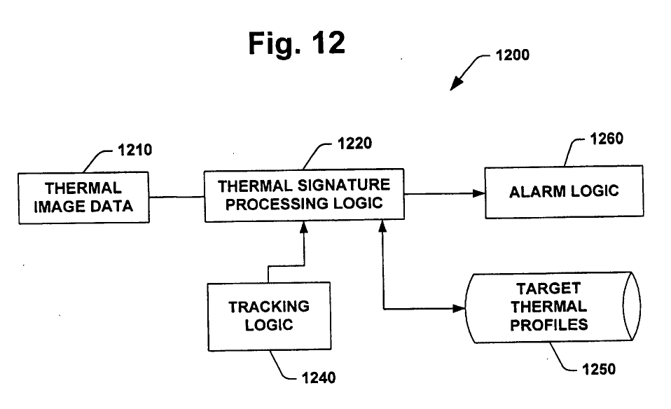

FIG. 12 of the present invention shows a thermal signature intensity processing system 1200 with associated tracking logic 1240. The system 1200 includes a thermal signature processing logic 1220 that receives and analyzes a thermal image data 1210. The logic 1220 facilitates identifying a thermal signature and potentially matching it with a signature stored in the data store 1250. Additionally, the logic 1240 can facilitate tracking an object of interest. Thus, the logic 1220 and the logic 1240 acquires a thermal image data 1210 from a thermal image data device, analyzes the thermal image data 1210 to identify a thermal signature for an object of interest in a region of interest, and selectively controls a thermal image data device to track the object of interest based on the thermal signature. Additionally, and/or alternatively, the logic 1240 and/or 1220 selectively controls a visual camera.

The systems and methods of the present invention described herein also facilitate thermal signature based target tracking. A thermal signature based target tracking system tracks objects identified by their thermal signature. Thus, targets within a pre-determined, configurable thermal intensity range can be tracked via IR, even if the target moves into an area where it might be lost by a conventional visual tracking system (e.g., camouflage area). The IR based target tracking can be initiated by methods like, a user designating a target to track, the system automatically designating a target to track based on its thermal signature or the like. Additionally, the thermal signature based target tracking can be combined with visual target tracking. The combined processing facilitates enhancing day/night capability.

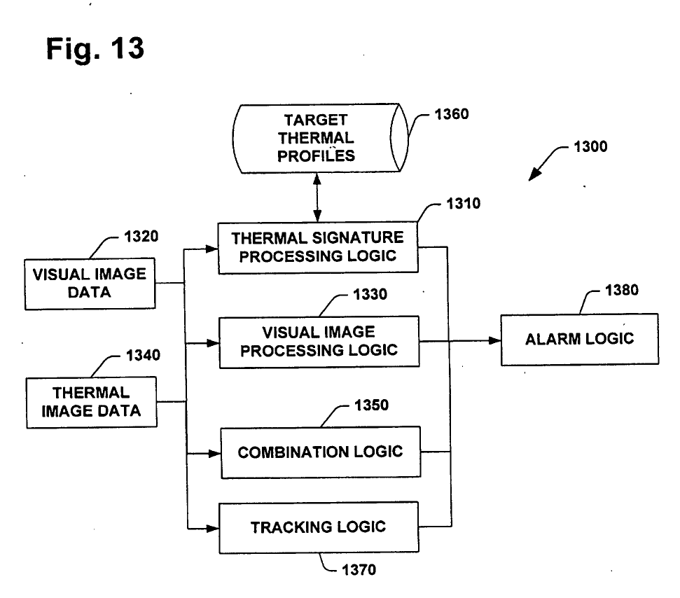

FIG. 13 of the present invention shows a combined thermal signature intensity and visual image processing system 1300 with associated tracking logic 1370. The system 1300 includes a thermal signature processing logic 1310 that acquires and analyzes a thermal image data 1340. The system 1300 also includes a visual image processing logic 1330 that acquires and processes a visual image data 1320. The visual image data 1320 is processed by generating a presentation of the visual image data 1320 where the presentation includes enhancing one or more objects whose thermal signature intensity is within a pre-determined, configurable range. Thus, the thermal signature processing logic 1310 identifies a thermal intensity signature and match it with one or more signatures stored in the data store 1360. Then, combination logic 1350 enhances the visual image produced by the logic 1330. Enhancement occurs by outlining the object with the matched thermal signature. Then, with the object highlighted, the tracking logic 1370 distinguishes viewer tracking of the object through the combination of visual and thermal data.

It is important to note that IR cameras are typically employed for night vision with visual cameras employed for daytime vision. However, combining visual cameras with IR cameras enhances daytime visual imaging by facilitating bringing attention to (e.g., highlighting, coloring), warm objects while providing the typical visual details of visual imaging.

### EXAMPLE 9

Consider a soldier wearing a camouflage uniform hiding in vegetation in a tree line. With a visual camera, the soldier may not be perceived by a viewer. With an IR camera, details that, the visual camera can detect can be lost. With the combination of the two cameras, the soldier thermal signature will be detected, and the example systems and methods can “paint” the soldier thermal signature on the image provided by the visual camera. Thus, the viewer will see the scenery in the field of view in detail with the natural color from the visual system, with the thermal signature outline of the soldier enhanced.

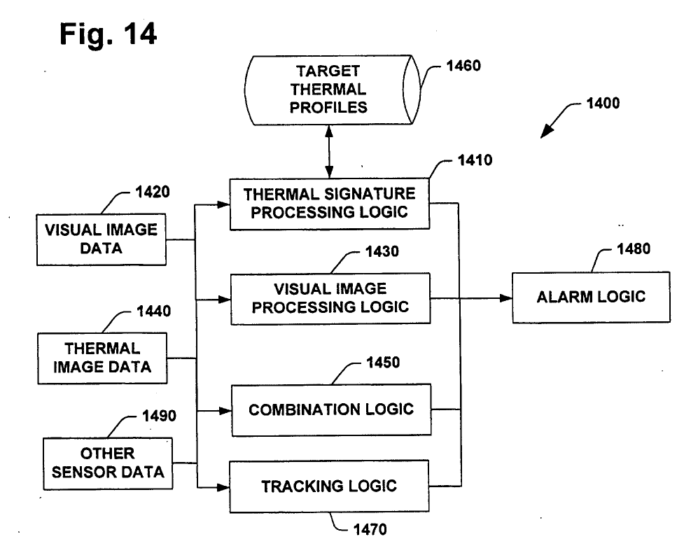

FIG. 14 of the present invention shows a combined thermal signature intensity and visual image processing system 1400 with other sensors and associated tracking logic. The system 1400 incorporates substantially all the image processing, thermal signature processing, tracking, combination and other logic described above. Additionally, the system 1400 processes other sensor data 1490. The other sensor data 1490 may be acquired from sensor devices such as a listening device, a satellite, a pressure sensor, a chemical sensor, a wind speed sensor, a seismic sensor or the like. Thus, the system 1400 performs processing that includes acquiring a thermal image data 1440 and analyzing the thermal image data 1440 to identify a thermal signature intensity for an object of interest in a region of interest. The region of interest may be established manually and/or automatically in response to information processed from the other sensor data 1490. It is important to note that a seismic sensor can also be utilized to identify an event in a location that causes the visual image data acquirer and thermal image data acquirer to scan the location identified by the seismic sensor. Thus, the system 1400 also analyzes data from visual image data 1420 to better characterize the object of interest. Thus, other sensor data 1490 automatically causes the visual image data acquirer and the thermal image data acquirer to scan a region in which an object of interest (e.g., human intruder) is identified. Thereafter, the tracking logic 1470 can track the object while alarm logic 1480 notifies people and/or processes interested in the alarm situation. The system 1400, with the other sensor data 1490, the visual image data 1420, and the thermal image data 1440 is capable of characterizing an object of interest beyond a thermal signature identification. Thus, the system 1400 details the characterization of an object of interest includes by also identifying a location of the object, identifying a size of the object, identifying the presence of the object, identifying the path of the object, and identifying the likelihood that the object is an intruder for which an alarm signal should be generated.

While combination processing involving IR and visual camera systems have been described above, it is to be appreciated that the systems and methods of the present invention are capable of operating with other sensors including, but not limited to, PIR, seismic, acoustic, ground search radar, air search radar, satellite imagery, and so on. Presentation apparatus (e.g., computer monitor, television) associated with the example systems and methods can then present an integrated tactical picture that presents data like, the location of a sensor, the direction the sensor is facing, current/historical alarms from a sensor, detected objects, object paths, and so on. The integrated tactical picture may be displayed, for example, on a topographical map, a real-time overhead image, a historical overhead image (e.g., satellite photograph) and so on.

The additional sensors can be employed to direct thermal and/or visual cameras to areas of interest (e.g., potential intrusion detected site). In this configuration, the example systems and methods with the additional sensors operate with the imaging systems to provide intruder detection and/or threat assessment. Furthermore, data from the additional sensors can be input into an intruder recognition system and/or method to facilitate identifying intruders. It is important to note that the present invention provides for a thermal signature to be combined with a sound signature to facilitate distinguishing between, for example, a truck and a tank.

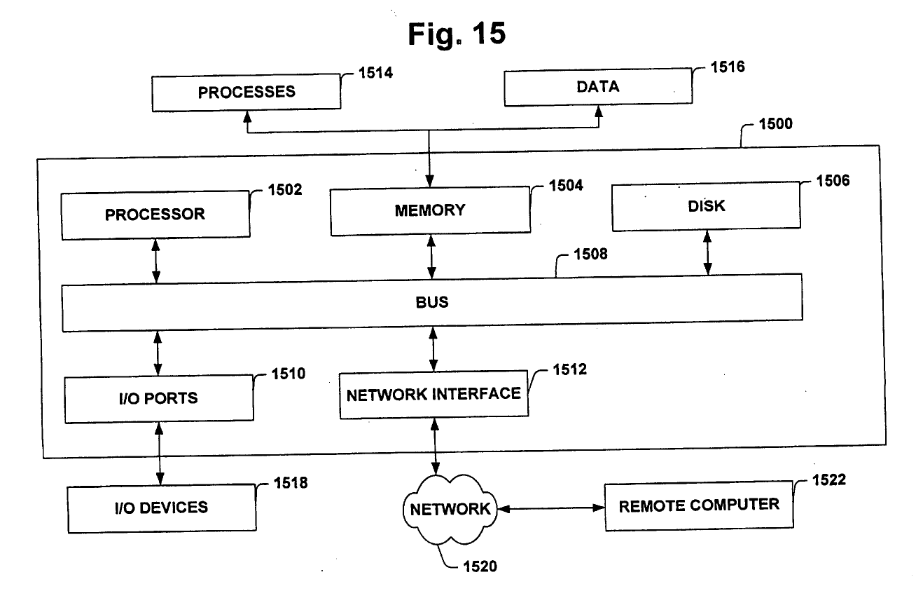

FIG. 15 of the present invention is a schematic block diagram of an example computing environment with which the example systems and method can interact. FIG. 15 shows a computer 1500 that includes a processor 1502, a memory 1504, a disk 1506, input/output ports 1510, and a network interface 1512 operably connected by a bus 1508. Executable components of the systems described herein can be located on a computer like computer 1500. Similarly, computer executable methods described herein may be performed on a computer like computer 1500. It is within the scope of the present invention that other computers can also be employed with the systems and methods described herein. The processor 1502 can be a variety of various processors including dual microprocessor and other multi-processor architectures. The memory 1504 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM). The disk 1506 can include, but is not limited to, devices such as a magnetic disk drive, a floppy disk drive, a tape drive, a Zip drive, a flash memory card, and/or a memory stick. Furthermore, the disk 1506 can include optical drives like, a compact disk ROM (CD-ROM), a CD recordable drive (CD-R drive), a CD rewriteable drive (CD-RW drive) and/or a digital versatile ROM drive (DVD ROM). The memory 1504 can store processes 1514 and/or data 1516. The disk 1506 and/or memory 1504 can store an operating system that controls and allocates resources of the computer 1500. The bus 1508 can be a single internal bus interconnect architecture and/or other bus architectures. The bus 1508 can be of a variety of types including, but not limited to, a memory bus or memory controller, a peripheral bus or external bus, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus. The computer 1500 interacts with input/output devices 1518 via input/output ports 1510. Input/output devices 1518 can include, but are not limited to, a keyboard, a microphone, a pointing and selection device, cameras, video cards, displays, and the like. The input/output ports 1510 can include but are not limited to, serial ports, parallel ports, and USB ports. The computer 1500 operates in a network environment and thus is connected to a network 1520 by a network interface 1512. Through the network 1520, the computer 1500 can be logically connected to a remote computer 1522. The network 1520 can include, but is not limited to, local area networks (LAN), wide area networks (WAN), and other networks. The network interface 1512 can connect to local area network technologies including, but not limited to, fiber distributed data interface (FDDI), copper distributed data interface (CDDI), ethernet/IEEE 802.3, token ring/IEEE 802.5, and the like. Similarly, the network interface 1512 can connect to wide area network technologies including, but not limited to, point to point links, and circuit switching networks like integrated services digital networks (ISDN), packet switching networks, and digital subscriber lines (DSL). Since the computer 1500 can be connected with other computers, and since the systems and methods described herein may include distributed communicating and cooperating computer components, information may be transmitted between these components.

In a preferred embodiment, an IIR module is incorporated into an apparatus that also includes one or more computer components for running associated application software. In another preferred embodiment, an IIR module and one or more computer components are distributed between two or more logical and/or physical apparatus. Thus, the IIR module and the computer components for running associated application software may engage in computer communications across a computer network.

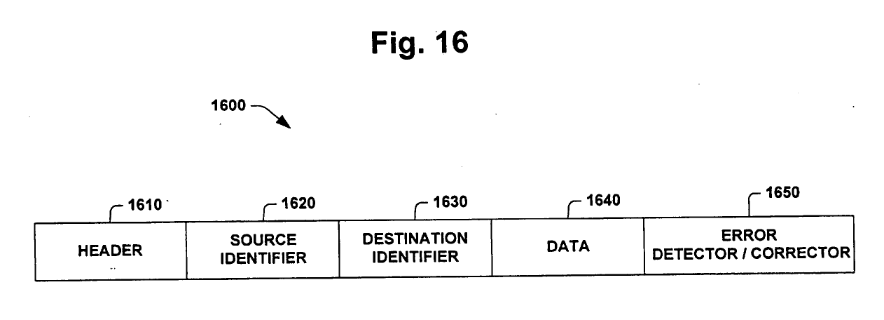

FIG. 16 of the present invention shows a data packet, where information can be transmitted between various computer components associated with the example systems and methods described herein via a data packet 1600. The data packet 1600 includes a header field 1610 that includes header identifying information such as the length and type of packet. A source identifier 1620 follows the header field 1610 and includes other relevant identifying information such as an address of the computer component from which the packet 1600 originated. Following the source identifier 1620, the packet 1600 includes a destination identifier 1630 that holds, for example, an address of the computer component to which the packet 1600 is ultimately destined. Source and destination identifiers can be, for example, globally unique identifiers (guids), URLS (uniform resource locators), path names, and the like. The data field 1640 in the packet 1600 includes various information intended for the receiving computer component. The data packet 1600 ends with an error detecting and/or correcting 1650 field whereby a computer component can determine if it has properly received the packet 1600. While five fields are illustrated in the data packet 1600, it is to be appreciated that a greater and/or lesser number of fields can be present in data packets.

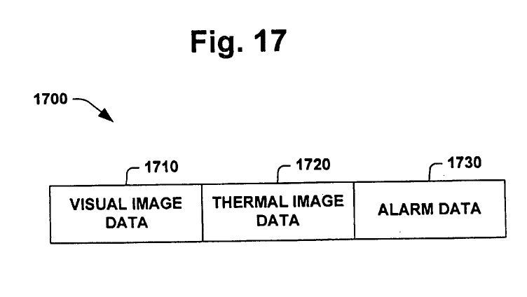

FIG. 17 of the present invention is a schematic diagram of sub-fields 1700 within the data field 1640 as shown in FIG. 16. The sub-fields 1700 discussed are merely exemplary and it is to be appreciated that a greater and/or lesser number of sub-fields could be employed with various types of data germane to processing thermal and/or visual image data. The sub-fields 1700 include a field 1710 that holds information concerning visual image data. The sub-fields 1700 also include a field 1720 that holds information concerning thermal image data.

The systems and methods of the present invention generate an alarm based on thermal and/or visual image data like that stored in the subfields 1710 and 1720, thus, the sub-fields 1700 include a field 1730 that stores information concerning alarm data 1730 associated with the visual image data in field 1710 and/or the thermal image data in field 1720.

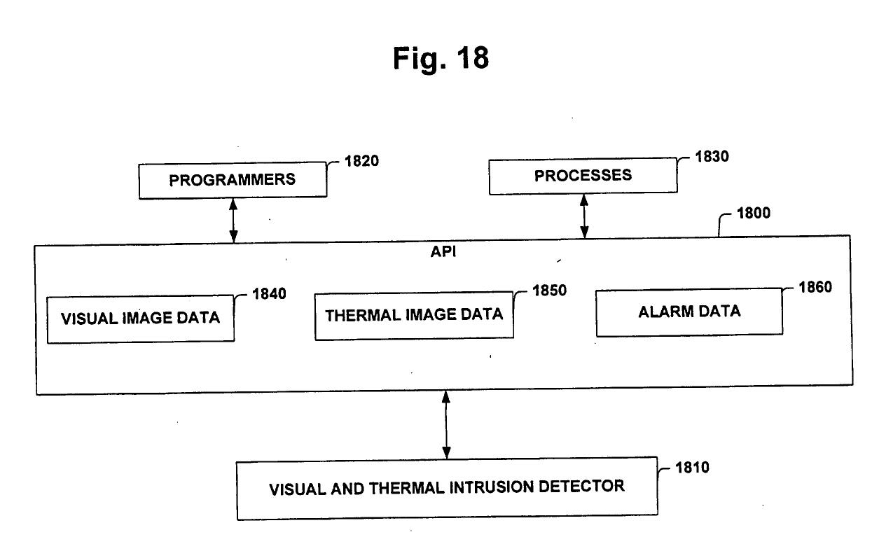

Referring now to FIG. 18 of the present invention, an application programming interface (API) 1800 is shown providing access to a system 1810 for intrusion detection. The API 1800 can be employed by programmers 1820 and/or processes 1830 to gain access to processing performed by the system 1810. It is important to note that a programmer 1820 can write a program to access the system 1810 (e.g., to invoke its operation, to monitor its operation, to access its functionality) where writing a program is facilitated by the presence of the API 1800. Thus, rather than the programmer 1820 having to understand the internals of the intrusion detection system 1810, the programmer's task is simplified by merely having to learn the interface to the system 1810. This facilitates encapsulating the functionality of the intrusion detection system 1810 while exposing that functionality. Similarly, the API 1800 can be employed to provide data values to the system 1810 and/or retrieve data values from the system 1810. A process 1830 that processes visual image data can provide this data to the system 1810 via the API 1800 by using a call provided in the portion 1840 of the API 1800. Similarly, a programmer 1820 concerned with thermal image data can transmit this data via a portion 1850 of the interface 1800.

Thus, in one embodiment of the API 1800, a set of application program interfaces can be stored on a computer-readable medium. The interfaces can be employed by a programmer, computer component, and/or process to gain access to an intrusion detection system 1810. Interfaces can include, but are not limited to, a first interface 1840 that communicates a visual image data, a second interface 1850 that communicates a thermal image data, and a third interface 1860 that communicates an alarm data generated from one or more of the thermal image data and the visual image data.

In an embodiment of the present invention, an infrared and visual intrusion detector provides a graphical user interface through which users can configure various values associated with the intrusion detection. Values including, but not limited to, a lower thermal intensity boundary, an upper thermal intensity boundary, a region of interest, a bit depth for color acquisition, a frame size for image acquisition, a frequency of frame capture, a motion sensitivity value, an output display quality, or the like, can be configured.

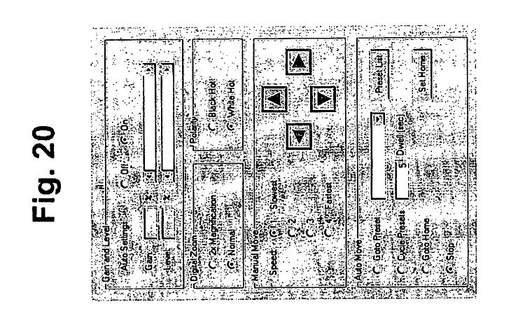

FIG. 19 illustrates an screen shot from a thermal signature intensity alarming system. Similarly, FIGS. 20, 21 and 22 show screen shots associated with a thermal signature intensity alarming system. Please note that the images shown in FIG. 19 through FIG. 22 are the copyrighted property of Raytheon Company and obtained, with permission by the inventor of the present invention, for the purposes of explaining the system and method of the present invention.

The systems, methods, and objects according to the present invention and described herein can be stored on a computer readable media. Media can include, but are not limited to, an ASIC, a CD, a DVD, a RAM, a ROM, a PROM, a disk, a carrier wave, a memory stick, and the like. Thus, a computer readable medium can store computer executable instructions for IR intrusion detection systems.

What has been described above includes several examples. It is, of course, not possible to describe every conceivable combination of components or methodologies for purposes of describing the systems, methods, computer readable media and so on employed in IR based intrusion detection. However, one of ordinary skill in the art may recognize that further combinations and permutations are possible. Accordingly, this application is intended to embrace alterations, modifications, and variations that fall within the scope of the appended claims. Furthermore, the preceding description is not meant to limit the scope of the invention. Rather, the scope of the invention is to be determined only by the appended claims and their equivalents.

While the systems, methods and so on herein have been illustrated by describing examples and embodiments, it is not the intention of the applicants to restrict or in any way limit the scope of the present invention. Additional advantages and modifications will be readily apparent to those skilled in the art.

What is claimed is:

1. A system, comprising:
a thermal signature processing logic that analyzes a thermal image data with respect to a background, which has a dynamically changing thermal signature, to identify an object of interest by a thermal signature; an intensity logic that determines the relative thermal intensity of the object of interest; and an alarm logic that determines whether an alarm-worthy event has occurred based on one or more of the thermal signature processing logic analysis of the thermal image data and the intensity logic analysis of the relative thermal intensity of the object of interest.

2. The system of claim 1, where the alarm logic determines whether an alarm-worthy event has occurred based on one or more values produced by the thermal signature processing logic or the intensity logic where the one or more values are produced by processing the value of an individual pixel or a set of pixels.

3. The system of claim 1, where the alarm logic determines whether an alarm-worthy event has occurred based on one or more values produced by the thermal signature processing logic or the intensity logic where the one or more values are produced by processing the effect an individual pixel or set of pixels has on an average value for a region of interest.

4. A computer readable medium storing computer executable components of the system of claim 1.

5. A system, comprising: a thermal signature processing logic that analyzes a thermal image data with respect to a background, which has a dynamically changing thermal signature to identify an object of interest by a thermal signature; a motion logic that determines whether an object of interest moved; and an alarm logic that determines whether an alarm-worthy event has occurred based on one or more of, the thermal signature processing logic analysis of the thermal image data and the motion logic analysis of the motion of the object of interest.

6. The system of claim 5, where the alarm logic determines whether an alarm-worthy event has occurred based on one or more values produced by the thermal signature processing logic or the motion logic where the one or more values are produced by processing the value of an individual pixel or a set of pixels.

7. The system of claim 5, where the alarm logic determines whether an alarm-worthy event has occurred based on one or more values produced by the thermal signature processing logic or the motion logic where the one or more values are produced by processing the effect an individual pixel or set of pixels has on an average value for a region of interest.

8. A computer readable medium storing computer executable components of the system of claim 5.

9. A system, comprising: a thermal signature processing logic that analyzes a thermal image data with respect to a background, which has a dynamically changing thermal signature to identify an object of interest by a thermal signature; a motion logic that determines whether an object of interest moved; an intensity logic that determines the relative thermal intensity of the object of interest; and an alarm logic that determines whether an alarm-worthy event has occurred based on one or more of, the thermal signature processing logic analysis of the thermal image data, the motion logic analysis of the motion of the object of interest, and the intensity logic analysis of the relative thermal intensity of the object of interest.

10. The system of claim 9, where the alarm logic determines whether an alarm-worthy event has occurred based on one or more values produced by the thermal signature processing logic, the motion logic, or the intensity logic where the values are produced by processing the value of an individual pixel or a set of pixels.

11. The system of claim 9, where the alarm logic determines whether an alarm-worthy event has occurred based on one or more values produced by the thermal signature processing logic, the motion logic, or the intensity logic where the values are produced by processing the effect an individual pixel or set of pixels has on an average value for a region of interest.

12. A computer readable medium storing computer executable components of the system of claim 9.

13. A system, comprising: a visual processing logic that analyzes a visual image data;
a thermal signature processing logic that analyzes a thermal image data with respect to a background, which has a dynamically changing thermal signature;
a combination logic that analyzes a combination of the visual image data and the thermal image data or that determines a relation between them; and
an alarm logic for determining whether an alarm-worthy event has occurred based on one or more of the visual processing logic analysis of the visual image data, the thermal signature processing logic analysis of the thermal image data, and the combination logic analysis of the combination of the visual image data and the thermal image data or the relation between the visual image data and the thermal image data.

14. The system of claim 13, comprising a frame capturer that captures between 10 and 60 frames per second.

15. The system of claim 14, where the frame capturer is one of a peripheral component interconnect frame grabber and a universal serial bus frame grabber.

16. The system of claim 13, where the visual image data is taken from a single frame.

17. The system of claim 13, where the visual image data is taken from two or more frames.

18. The system of claim 15, where the peripheral component interconnect frame grabber samples data at a resolution of between 128.times.128 pixels and 1024.times.1024.

19. The system of claim 15, where the peripheral component interconnect frame grabber samples data with a color depth of between 4 and 16 bits per pixel.

20. The system of claim 13, where the visual processing logic includes a visual image data transforming logic.

21. The system of claim 20, where the visual image data transforming logic performs one or more of, blurring, sharpening, and filtering of the visual image data.

22. The system of claim 13, where the alarm logic determines whether an alarm-worthy event has occurred by evaluating the value of one or more pixels in the visual image data or the thermal image data on an individual basis.

23. The system of claim 13, where the alarm logic determines whether an alarm-worthy event has occurred by evaluating values of a set of pixels in the visual image data or the thermal image data on an averaged basis.

24. The system of claim 13, where the alarm logic determines whether an alarm-worthy event has occurred by comparing a motsig data to a pre-determined, configurable range for the motsig data.

25. A computer readable medium storing computer executable components of the system of claim 13.

26. A method, comprising: acquiring a thermal image data;
analyzing the thermal image data to identify a thermal signature intensity for an object of interest in a region of interest with respect to a background, which has a dynamically changing thermal signature;
determining whether an alarm signal should be generated based on the thermal signature intensity of the object of interest; and
selectively generating an alarm signal.

27. A method, comprising: acquiring a thermal image data;
analyzing the thermal image data to identify a motion for an object of interest in a region of interest with respect to a background, which has a dynamically changing thermal signature;
determining whether an alarm signal should be generated based on the motion of the object of interest; and selectively generating an alarm signal.

28. A method, comprising:
acquiring a thermal image data;
analyzing the thermal image data with respect to a background, which has a dynamically changing thermal signature to identify a thermal signature intensity for an object of interest in a region of interest;
analyzing the thermal image data to identify a motion for the object of interest in a region of interest; determining whether an alarm signal should be generated based on the motion of the object of interest or the thermal signature intensity of the object of interest; and
selectively generating an alarm signal.

29. A method, comprising:
acquiring a visual image data;
acquiring a thermal image data;
analyzing the visual image data and the thermal image data with respect to a background, which has a dynamically changing thermal signature to determine whether an alarm-worthy event has occurred; and
selectively generating an alarm signal based on the analyzing of the visual image data and the analyzing of the thermal image data.

30. The method of claim 29, where the visual image data is acquired from a frame grabber.

31. The method of claim 29, where the thermal image data is acquired from an infrared apparatus.

32. The method of claim 29, comprising: transforming the visual image data by one or more of blurring, sharpening, and filtering.

33. The method of claim 29, where an alarm signal is generated based on the value of a single pixel.

34. The method of claim 29, where an alarm signal is generated based on the average value of a set of two or more pixels.

35. The method of claim 29, where an alarm signal is generated based on data from a single frame.

36. The method of claim 29, where an alarm signal is generated based on data from a set of two or more frames.

37. A computer readable medium storing computer executable instructions operable to perform computer executable aspects of the method of claim 29.

38. A method, comprising:
acquiring a thermal image data;
analyzing the thermal image data to identify a thermal signature intensity for an object of interest in a region of interest with respect to a background, which has a dynamically changing thermal signature;
acquiring a visual image data;
generating a presentation of the visual image data where the presentation includes enhancing one or more objects whose thermal signature intensity is within a pre-determined, configurable range.

39. A computerized method, comprising:
acquiring a thermal image data;
analyzing the thermal image data to identify a thermal signature for an object of interest in a region of interest with respect to a background, which has a dynamically changing thermal signature;
accessing a data store of thermal signatures; and
generating a target identification based on comparing the identified thermal signature to one or more thermal signatures in the data store.

40. The method of claim 39, comprising: acquiring a visual image data; analyzing the visual image data in light of the target identification to refine the target identification.

41. The method of claim 40, comprising: selectively generating an alarm signal based on the target identification.

42. A method, comprising:
acquiring a thermal image data from a thermal image data device;
analyzing the thermal image data to identify a thermal signature for an object of interest in a region of interest with respect to a background, which has a dynamically changing thermal signature; and
selectively controlling the thermal image data device to track the object of interest based on the thermal signature.

43. The method of claim 42, comprising: automatically focusing the thermal image data device based on the thermal signature for the object of interest.

44. The method of claim 43, where automatically focusing the thermal image data device comprises maximizing a gradient between the object of interest and a background.

45. A method, comprising:
acquiring a thermal image data;
analyzing the thermal image data to identify a thermal signature intensity for an object of interest in a region of interest with respect to a background, which has a dynamically changing thermal signature;
acquiring a visual image data;
analyzing the visual image data to facilitate characterizing the object of interest; and
acquiring one or more external sensor data that further facilitate characterizing the object of interest.

46. The method of claim 45, where characterizing an object of interest comprises one or more of, identifying a location of the object, identifying a size of the object, identifying the presence of the object, identifying the path of the object, and identifying the likelihood that the object is an intruder for which an alarm signal should be generated.

47. A system for detecting an intrusion of an object of interest into a region of interest, comprising:
means for acquiring a thermal image of the region of interest with respect to a background, which has a dynamically changing thermal signature;
means for analyzing the thermal image to identify a thermal intensity signal of an object of interest; and
means for generating an alarm signal based on the analysis of the thermal image.

48. A system for detecting an intrusion of an object of interest into a region of interest, comprising:
means for acquiring a visual image of the region of interest;
means for acquiring a thermal image of the region of interest;
means for analyzing the visual image in relation to the thermal image with respect to a background, which has a dynamically changing thermal signature; and
means for generating an alarm signal based on the analysis of the visual image in relation to the thermal image.

49. A set of application programming interfaces embodied on a computer readable medium for execution by a computer component in conjunction with intrusion detection, comprising:
a first interface for communicating thermal image data with respect to a background, which has a dynamically changing thermal signature; and
a second interface for communicating alarm data, where the alarm data is computed based on analyzing the thermal image data.

50. In a computer system having a graphical user interface comprising a display and a selection device, a method of providing and selecting from a set of data entries on the display, the method comprising:
retrieving a set of data entries, each of the data entries representing one of an action associated with detecting an intrusion by analyzing thermal image data with respect to a background, which has a dynamically changing thermal signature;
displaying the set of entries on the display; receiving a data entry selection signal indicative of the selection device selecting a selected data entry; and
in response to the data entry selection signal, initiating an operation associated with the selected data entry.

51. A computer data signal embodied in a transmission medium, comprising:
a first set of instructions for processing thermal image data with respect to a background, which has a dynamically changing thermal signature; and
a second set of instructions for determining that an intrusion by an object of interest into a region of interest has occurred based on processing of the thermal image data.

52. A data packet for transmitting intrusion data, comprising:
a first field that stores image data determined with respect to a background, which has a dynamically changing thermal signature; and
a second field that stores alarm data computed from analyzing the thermal image data.
